(19) United States
(12) Patent Application Publication
(10) Pub. No.: US 2025/0245062 A1
(43) Pub. Date: Jul. 31, 2025

(54) SERVICE SCALING BASED ON SERVICE DEPENDENCIES

(71) Applicant: Dell Products L.P., Round Rock, TX (US)

(72) Inventors: RAVEENDRA BABU MADALA, Agiripalli (IN); SANTOSH GORE, Bangalore (IN); PARMESHWR PRASAD, Bangalore (IN)

(21) Appl. No.: 18/426,784

(22) Filed: Jan. 30, 2024

(51) Int. Cl. G06F 9/50

(52) U.S. Cl. CPC G06F 9/505

(57) ABSTRACT

Methods and systems for managing services are disclosed. The services may be managed by monitoring the services to identify services that could benefit from being scaled. The services may be identified by monitoring operation of both the services and dependencies of the services. The monitoring may allow services to be classified as either being limited in processing due to computing resource limits or limited due to dependencies. Services that are limited due to computing resource may be candidates for scaling. Such services may be scaled if timeliness or other goals of the services are not met.

### FIELD

Embodiments disclosed herein relate generally to managing services. More particularly, embodiments disclosed herein relate to managing scaling of services based on fulfillment of a service level agreement.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2B show data flow diagrams illustrating operation of a system in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing services. The services may be managed by monitoring fulfillment of a service level agreement (SLA) by services and the dependencies. The fulfillment of the SLA may be monitored by an outcome SLA monitor (OSM).

When a request is made by a user, an application programming interface (API) may receive the request. Upon receiving the request, the API may instantiate services and dependencies to carry out tasks to fulfill the request. Load information may be provided for the services and the dependencies. The load information may include processing limits for the services and the dependencies.

The OSM may receive the request alongside the API and monitor execution of tasks by the services and the dependencies. The OSM may monitor execution of the tasks by receiving messages from the services and the dependencies. The services and the dependencies may communicate when the services and/or the dependencies may be overloaded. When the services and/or the dependencies may be overloaded, the processing limits of the services and/or the dependencies may be reached or exceeded.

In response to overloading by the services and/or the dependencies, the OSM may scale the service and/or the dependencies. By scaling the service and/or the dependencies, the OSM may create a new instance of the services and/or the dependencies. Upon scaling the service and/or the dependencies, a processing load between the service and/or the dependencies and the new instance of the services and/or the dependencies may be rebalanced. Rebalancing of the processing load may reduce the likelihood of overloading by one of more of the services and/or the dependencies.

In an embodiment, a method for managing services is disclosed. The method may include (i) obtaining an application programming interface request; (ii) obtaining a list of services and a list of dependencies of the services necessary to service the application programming interface request; (iii) obtaining first load information for the services and second load information for the dependencies of the services; (iv) performing an analysis using the first load information and the second load information to identify at least one of the services and/or the dependencies of the services that is likely to prevent the application programming interface request from being serviced in accordance with a service level agreement; (v) scaling the at least one of the services and the dependencies of the services to improve the likelihood of the application programming interface request being serviced in accordance with the service level agreement; and (vi) servicing the application programming interface request using the scaled at least one of the services and the dependencies of the services.

The list of services includes identifiers of executing services that will be used to complete first tasks to be performed by the application programming interface to service the application programming interface request.

The list of the dependencies includes second identifier of other executing services that will be used to complete second tasks to be performed by the executing services identified by the list of services to service the application programming interface request.

The first load information for a first service of the services quantifies how close to a limit on a rate at which the first service is able to process requests that the first service is currently being asked to process.

The second load information for a first dependency of the dependencies quantifies how close to a second limit on a second rate at which the first dependency is able to process requests from at least the first service that the first dependency is currently being asked to process.

Performing the analysis includes, for a service of the list of the services: (i) comparing the first load information to a first load threshold for the service to identify a load state of the service; (ii) making a determination regarding whether the load state indicates that the service is likely to prevent the application programming interface request from being serviced in accordance with the service level agreement; (iv) in a first instance of the determination where the load state indicates that the service is likely to prevent the application programming interface request from being serviced in accordance with the service level agreement: (a) concluding that service is to be scaled; and (v) in a second instance of the determination where the load state indicates that the service is unlikely to prevent the application programming interface request from being serviced in accordance with the service level agreement: (a) concluding that scaling the service is unlikely to impact a likelihood of the application programming interface request from being serviced in accordance with the service level agreement.

Performing the analysis further includes, for a dependency of the list of the dependencies that is a dependency of the service: (i) comparing the second load information to a second load threshold for the dependency to identify a second load state of the dependency; (ii) making a second determination regarding whether the second load state indicates that the dependency is likely to prevent the application programming interface request from being serviced in accordance with the service level agreement; (iii) in a first instance of the second determination where the second load state indicates that the dependency is likely to prevent the application programming interface request from being serviced in accordance with the service level agreement: (a) concluding that dependency is to be scaled; and (iv) in a second instance of the determination where the second load state indicates that the dependency is unlikely to prevent the application programming interface request from being serviced in accordance with the service level agreement: (a) concluding that scaling the dependency is unlikely to impact a likelihood of the application programming interface request from being serviced in accordance with the service level agreement.

Scaling the at least one of the services and the dependencies of the services includes creating a new instance of the at least one of the services and the dependencies of the services.

Creating a new instance includes, based on an identification that the services are unlikely to prevent the application programming interface request from being serviced in accordance with the service level agreement but that at least one of the dependencies of the services is likely to prevent the application programming interface request from being serviced in accordance with the service level agreement, (i) instantiating a new instance of the at least one of the dependencies; and (ii) establishing a load balancing scheme for the new instance of the at least one of the dependencies to reduce load on the dependencies.

Servicing the application programming interface request includes using the new instance to load balance processing performed to service the application programming interface request to reduce load on the at least one of the services and the dependencies of the services to participate in the processing.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

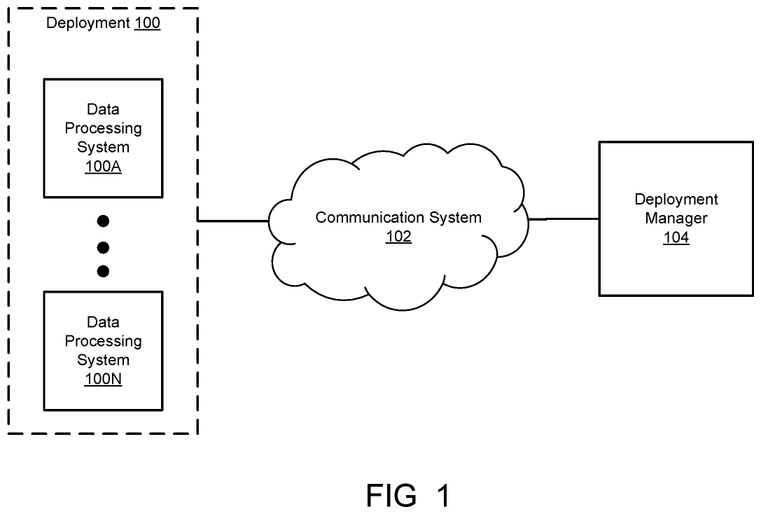

Turning to FIG. 1, a system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, the system may utilize a service based solution architecture. The service based solution architecture may include any number of services (e.g., microservice) that may perform various functions. Different services may perform similar or different functions.

To provide a particular computer implemented service, multiple services may be invoked. For example, an application programming interface (API) may receive a request with various information usable to identify a type of computer implemented service to provide. The API may, based on the identified type of the computer implemented service, invoke various services to perform some functions as part of the computer implemented services. These initially invoked services may, in turn, invoke other services to contribute additional functions as part of the computer implemented services.

Each service may be allocated a finite quantity of resources to use in operation. Consequently, invocation of a service too frequently may cause some of the invocations to be queued for performance in the future due to computing resource limitations.

If the queue is of a sufficient depth, then the service may take an unusually long time to complete its operation once invoked. Such delays may cause the computer implemented services to be provided in manners that do not meet various goals.

For example, a service level agreement may define timeliness of provisioning of computer implemented services (e.g., time limits regarding the duration of time between when a computer implemented service is requested and when it is provided). If the delays are of sufficient length, then the timeliness of the provisioning of the computer implemented services as defined by the service level agreement may not be met.

In general, embodiments disclosed here relate to systems and methods for improving the likelihood of providing computer implemented services in a manner that meets various goals such as timeliness. To improve the likelihood, the responses to requests received by a service based solution architecture may be monitored to ascertain whether the requests are serviced timely in accordance with a standard, such as a service level agreement.

When responses to requests are not meeting the timeliness standards, an investigation process may be performed. During the investigation process, each service of the service based solution architecture that is invoked to service a request may be monitored for timeliness. Additionally, each dependency (e.g., another service that is invoked by an already invoked service) of the service that is invoked may also be monitored for timeliness. The timeliness of the invoked services and their dependencies may be used to determine how to attempt to remediate the failure to meet the timeliness standard.

To identify whether services or their dependencies are not servicing requests timely due to computing resource limitations, the depths of queues of requests for the services and the dependencies may be monitored. The depth of each queue may be used to ascertain whether scaling the quantity of corresponding services or dependencies is likely to improve the timeliness of servicing requests (e.g., when requests are load balanced to the newly instantiated services/dependencies).

For example, if a service has a large queue depth, the service may be (or may not be) overloaded because requests in the queue are piling up. The requests in the queue may pile up because (i) the requests are coming in too quickly to service (i.e., a computing resource limitation), or (ii) dependencies of a service are not returning results quickly (e.g., an invoked service limitation). If a service is identified as not servicing requests timely (e.g., due to a large queue depth and/or measured processing time), then the time required by dependencies of the service to return results may be identified (e.g., may review the queue depths of the dependencies as well). If the time required for results to be returned is sufficiently large, then the dependency may be identified as the cause of the service not meeting the timeliness standard (as opposed to a lack of computing resources available to the service). In such a scenario, the dependency rather than the service may be considered for scaling. However, if the dependencies are providing results to the service timely, then the service may be considered for scaling.

When a dependency is identified as the cause of a service not meeting the timeliness standard, then a similar process may be repeated for each dependency of the dependency to identify whether the dependency is being hindered by its dependencies, or the dependency itself lacks sufficient resource access to return results timely.

Once a service and/or the dependencies of the service have been identified as the culprit, scaling of the services and/or the dependencies that have been identified may be performed. Load balancing and/or other techniques may also be applied to ensure use of the scaled services/dependencies.

By scaling the services and/or the dependencies that have been identified, more instances of the services and/or the dependencies may be available to service requests thereby allocating additional computing resources to improve the likelihood of meeting the timeliness standard. In addition, the processing load may be rebalanced to ensure that the new instances of the services and/or the dependencies are used to service future requests.

To provide the above noted functionality, the system may include deployment 100, and deployment manager 104. Each of these components is discussed below.

Deployment 100 may include any number of data processing systems 100A-100N. Data processing systems 100A-100N may provide the computer implemented services. To provide the computer implemented services, data processing systems 100A-100N and may host service based solution architectures which may include application programming interfaces, and various services (which may be logically arranged in a hierarchy establishing various dependencies between the services based on which services invoke other services). To facilitate management of the service based solution architecture, data processing systems 100A-100N may provide deployment manager 104 with information regarding the service based solution architecture (e.g., timeliness of servicing requests, logical dependencies between services, queue depths, etc.), scale services based on instructions from deployment manager 104, load balance across services as the services are scaled, and/or perform other actions.

Deployment manager 104 may manage the service based solution architectures hosted by data processing systems 100A-100N. To do so, deployment manager may (i) monitor the operation of the service based solution architecture, (ii) ascertain how to scale services of the service based solution architecture based on the monitoring, (iii) issue instructions to data processing systems 100A-100N to scale the services, and/or perform other actions.

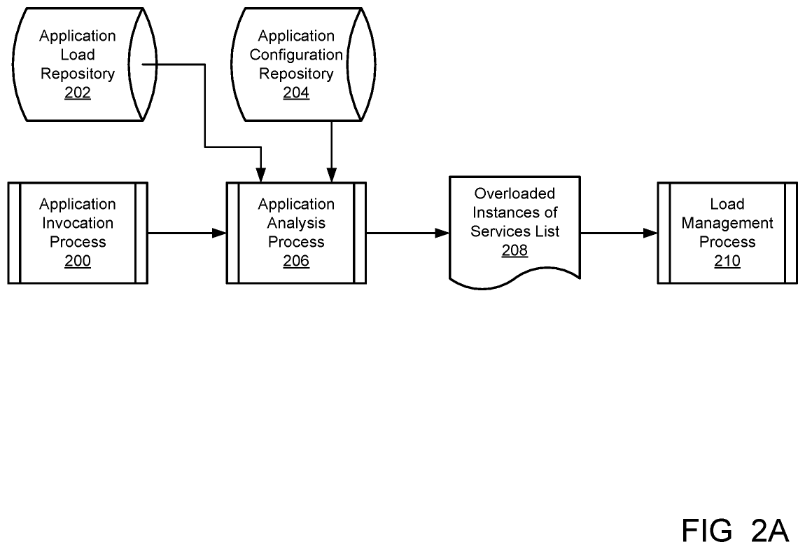

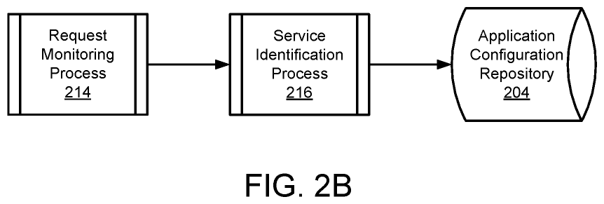

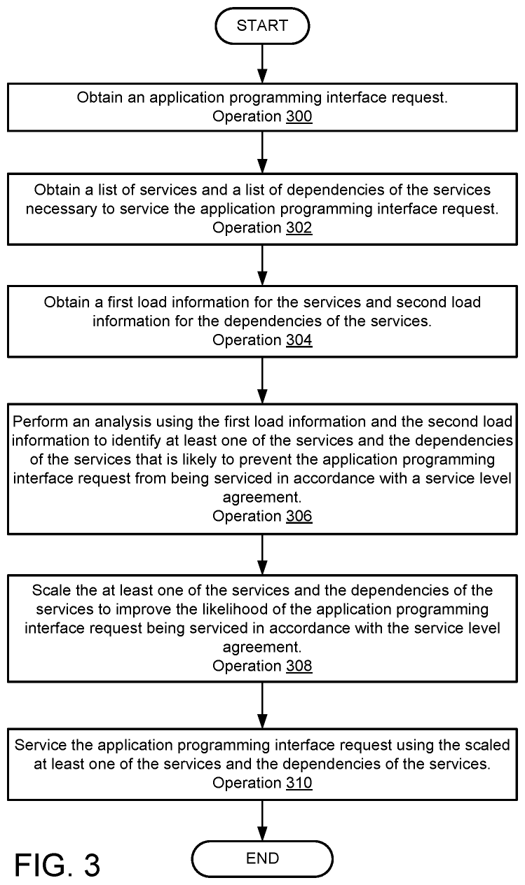

While providing their functionality, any of deployment 100 and deployment manager 104 may perform all, or a portion, of the flows and methods shown in FIGS. 2A-3.

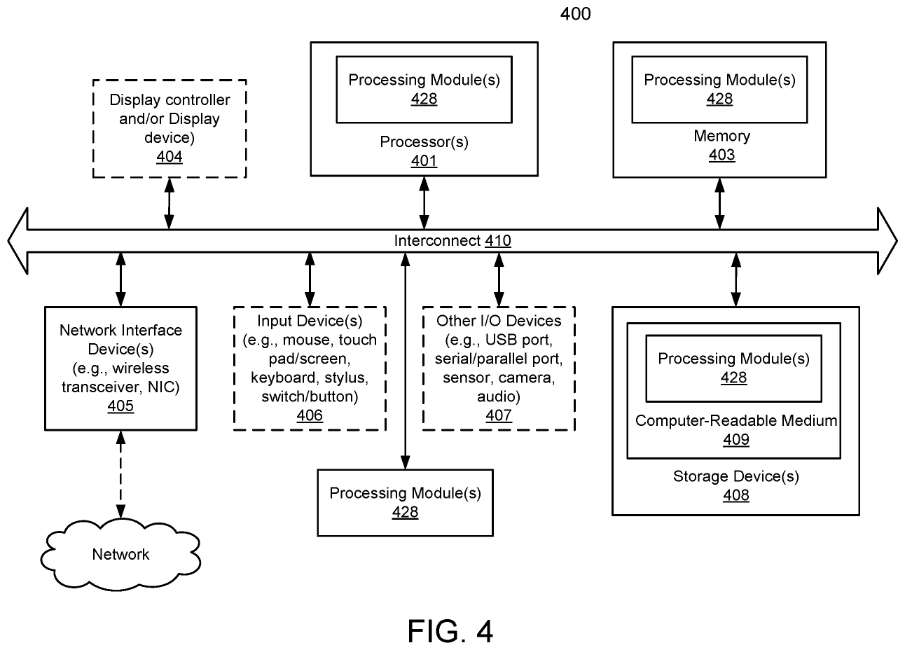

Any of (and/or components thereof) deployment 100 and deployment manager 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the Internet protocol).

While illustrated in FIG. 1 as including a limited number of specific components, a system in accordance with an embodiment may include fewer, additional, and/or different components than those components illustrated therein.

To further clarify embodiments disclosed herein, data flow diagrams in accordance with an embodiment are shown in FIGS. 2A-2B. In these diagrams, flows of data and processing of data are illustrated using different sets of shapes. A first set of shapes (e.g., 208) is used to represent data structures, a second set of shapes (e.g., 200, 206, etc.) is used to represent processes performed using and/or that generate data, and a third set of shapes (e.g., 202, 204, etc.) is used to represent large scale data structures such as databases.

Turning to FIG. 2A, a first data flow diagram in accordance with an embodiment is shown. The first data flow diagram may illustrate data used in and data processing performed in managing operation of a service based application architecture.

To manage the service based application architecture, application invocation process 200 may be performed. During application invocation process 200, a user may make a request through an API to obtain desired computer implemented services from the service based application architecture. The API may receive the request and invoke the functionality of any number of services of the service based application architecture to start servicing of the request for the desired computer implemented services.

To manage the operation of the service based application architecture, application analysis procedure 206 may be performed. During application analysis process 206, a list of services that will participate in providing the computer implemented services. The list of the services may be obtained from application configuration repository 204.

For example, application configuration repository 204 may include mappings between different types of requests and corresponding services of the service based application architecture that will be invoked to service such requests. The content of application configuration repository 204 may be obtained, for example, from a subject matter expert, an automated analysis process that tracks how the service based application architecture response to requests, and/or via other methods. Consequently, application configuration repository 204 may be used to identify services that will perform some part of the requested computer implemented services.

Once the list of services is obtained, load information for each of the services may be obtained from application load repository 202. Application load repository may include information regarding the load states of different services over time. The information may be obtained by, for example, monitoring the queue depth of each of the services and analyzing dependencies to identify whether the queue length of each services is due to either (i) limited available computing resources or (ii) dependence on another service (i.e., the service has a long queue due to another service not returning results or otherwise processing requests timely).

For those services and dependencies that are identified as limited due to available computing resources, each may be added to overloaded instance of services list 208. Overloaded instances of services list may be ingested by load management process 210.

During load management process 210, scaling may be applied to the services listed in overloaded instances of services list 208. The scaling may be applied by instantiating new instances of the listed services, and applying various load balancing mechanisms to ensure that the new instances share some of the workload.

Thus, using the method shown in FIG. 2A, services may be scaled in a manner that is more likely to improve servicing of requests by a service based application architecture to meet desired goals.

To facilitate identification of services that are likely to provide a benefit when scaled, information regarding the services may be collected.

Turning to FIG. 2B, a second data flow diagram in accordance with an embodiment is shown. The second data flow diagram may illustrate data used in and data processing performed in establishing relationships between services of a service based application architecture.

To establish relationships between different services, request monitoring process 214 may be performed. During request monitoring process 214, requests from users and directed to a service based application architecture may be monitored. When a request is received, the type of request may be identified and stored as part of a record.

Once the record is prepared, service identification process 216 may be performed. During service identification process 216, the services of the service based application architecture that are invoked due to the request may be identified. For example, headers or other information may be added to information passed between the services to invoke the services. Consequently, the services invoked as a consequence of the type of the request being obtained may be identified.

Information regarding these services may be added to the record, and the record may be stored in application configuration repository 204. Consequently, when future requests of the type are obtained, the record may be used to identify the services that are likely to be used to service the request. Accordingly, the load states of these identified services may be monitored to identify any services that are overloaded and could benefit from scaling.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage data processing systems. FIG. 3 illustrates a method that may be performed by the components of the system of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of servicing requests in accordance with an embodiment is shown. The method may be performed, for example, by any of the components of the system of FIG. 1, and/or other components not shown therein.

At operation 300, an API request may be obtained. The API request may be obtained by receiving the API request from a user (e.g., from a computer that is used by the user and operably connected to a service based application architecture).

At operation 302, a list of services and a list of dependencies of the services that are necessary to service the API request may be obtained. The list of services and the list of dependencies of the services may be obtained by extracting the list of services and the list of dependencies of the services from an application configuration repository, or other data structure that stores information regarding services and dependencies in relation to different types of requests. For example, the type of the request may be used to perform a lookup which may return the lists.

At operation 304, a first load information for the services and a second load information for the dependencies of the services may be obtained. The first load information and the second load information may be obtained by reading the first load information and the second load information from a data structure such as an application load repository. The application load repository may be populated with load information (e.g., queue lengths for the services/dependencies, duration of time for requests to be processed by services/dependencies, etc.) for the services/dependencies.

At operation 306, an analysis may be performed using the first load information and the second load information to identify at least one of the services and/or the dependencies of the services that is likely to prevent the API request from being serviced in accordance with a service level agreement. The analysis may be performed, for a service of the services, by (i) comparing the first load information to a first load threshold for the service to identify a load state of the service; (ii) making a determination regarding whether the load state indicates that the service is likely to prevent the API request from being serviced in accordance with the service level agreement; (iii) in a first instance of the determination where the load state indicates that the service is likely to prevent the API request from being serviced in accordance with the service level agreement: concluding that service is to be scaled, and (iv) in a second instance of the determination where the load state indicates that the service is unlikely to prevent the API request from being serviced in accordance with the service level agreement: concluding that scaling the service is unlikely to impact a likelihood of the API request from being serviced in accordance with the service level agreement.

The first load information may be compared to the first load threshold for the service by comparing the load state in the first load information to a processing limit for the service.

The analysis may be further performed, for a dependency of the list of the dependencies that is a dependency of the service, by (i) comparing the second load information to a second load threshold for the dependency to identify a second load state of the dependency; (ii) making a second determination regarding whether the second load state indicates that the dependency is likely to prevent the API request from being serviced in accordance with the service level agreement; (iii) in a first instance of the second determination where the second load state indicates that the dependency is likely to prevent the API request from being serviced in accordance with the service level agreement: concluding that dependency is to be scaled; and (iv) in a second instance of the determination where the second load state indicates that the dependency is unlikely to prevent the API request from being serviced in accordance with the service level agreement: concluding that scaling the dependency is unlikely to impact a likelihood of the API request from being serviced in accordance with the service level agreement.

The second load information may be compared to the second load threshold for the dependency by comparing the second load state in the second load information to a second processing limit for the service.

At operation 308, the at least one of the services and the dependencies of the services may be scaled to improve the likelihood of the API request being serviced in accordance with the service level agreement. The at least one of the services and the dependencies of the services may be scaled by creating a new instance of the at least one of the services and the dependencies of the services. Based on an identification that the services are unlikely to prevent the API request from being serviced in accordance with the service level agreement but that at least one of the dependencies of the services is likely to prevent the API request from being serviced in accordance with the service level agreement, a new instance of the at least one of the services and the dependencies of the services may be created by: (i) instantiating a new instance of the at least one of the dependencies; and (ii) establishing a load balancing scheme for the new instance of the at least one of the dependencies to reduce load on the dependencies.

At operation 310, the API request may be serviced using the scaled at least one of the services and the dependencies of the services. The API request may be serviced by using the new instance to load balance processing performed to service the API request to reduce load on the at least one of the services and the dependencies of the services to participate in the processing. The new instance may be used to load balance processing by sharing a total processing load with the at least one of the dependencies to service the API request.

The method may end following operation 310.

Thus, using the method illustrated in FIG. 3, embodiments disclosed herein may improve the efficiency of use of computing resources by improving the likelihood of scaling being performed for services that may benefit from scaling (e.g., that are computing resource constrained rather than being limited by other services).

Any of the components illustrated in FIGS. 1-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing services, the method comprising:
obtaining an application programming interface request;
obtaining a list of services and a list of dependencies of the services necessary to service the application programming interface request;
obtaining first load information for the services and second load information for the dependencies of the services;
performing an analysis using the first load information and the second load information to identify at least one of the services and/or the dependencies of the services that is likely to prevent the application programming interface request from being serviced in accordance with a service level agreement;
scaling the at least one of the services and the dependencies of the services to improve the likelihood of the application programming interface request being serviced in accordance with the service level agreement; and
servicing the application programming interface request using the scaled at least one of the services and the dependencies of the services.

2. The method of claim 1, wherein the list of services comprises identifiers of executing services that will be used to complete first tasks to be performed by the application programming interface to service the application programming interface request.

3. The method of claim 1, wherein the list of the dependencies comprises second identifier of other executing services that will be used to complete second tasks to be performed by the executing services identified by the list of services to service the application programming interface request.

4. The method of claim 1, wherein the first load information for a first service of the services quantifies how close to a limit on a rate at which the first service is able to process requests that the first service is currently being asked to process.

5. The method of claim 4, wherein the second load information for a first dependency of the dependencies quantifies how close to a second limit on a second rate at which the first dependency is able to process requests from at least the first service that the first dependency is currently being asked to process.

6. The method of claim 1, wherein performing the analysis comprises:
for a service of the list of the services:
comparing the first load information to a first load threshold for the service to identify a load state of the service;
making a determination regarding whether the load state indicates that the service is likely to prevent the application programming interface request from being serviced in accordance with the service level agreement;
in a first instance of the determination where the load state indicates that the service is likely to prevent the application programming interface request from being serviced in accordance with the service level agreement:
concluding that service is to be scaled;
in a second instance of the determination where the load state indicates that the service is unlikely to prevent the application programming interface request from being serviced in accordance with the service level agreement:
concluding that scaling the service is unlikely to impact a likelihood of the application programming interface request from being serviced in accordance with the service level agreement.

7. The method of claim 6, wherein performing the analysis further comprises:
for a dependency of the list of the dependencies that is a dependency of the service:
comparing the second load information to a second load threshold for the dependency to identify a second load state of the dependency;
making a second determination regarding whether the second load state indicates that the dependency is likely to prevent the application programming interface request from being serviced in accordance with the service level agreement;
in a first instance of the second determination where the second load state indicates that the dependency is likely to prevent the application programming interface request from being serviced in accordance with the service level agreement:
concluding that dependency is to be scaled:
in a second instance of the determination where the second load state indicates that the dependency is unlikely to prevent the application programming interface request from being serviced in accordance with the service level agreement:
concluding that scaling the dependency is unlikely to impact a likelihood of the application programming interface request from being serviced in accordance with the service level agreement.

8. The method of claim 1, wherein scaling the at least one of the services and the dependencies of the services comprises:
creating a new instance of the at least one of the services and the dependencies of the services.

9. The method of claim 8, wherein creating a new instance comprises:
based on an identification that the services are unlikely to prevent the application programming interface request from being serviced in accordance with the service level agreement but that at least one of the dependencies of the services is likely to prevent the application programming interface request from being serviced in accordance with the service level agreement:
instantiating a new instance of the at least one of the dependencies; and
establishing a load balancing scheme for the new instance of the at least one of the dependencies to reduce load on the dependencies.

10. The method of claim 8, wherein servicing the application programming interface request comprises:
using the new instance to load balance processing performed to service the application programming interface request to reduce load on the at least one of the services and the dependencies of the services to participate in the processing.

11. A non-transitory machine-readable medium having instructions stored therein, which when executed by a processor, cause the processor to perform operations for managing services, the operation comprising:
obtaining an application programming interface request;
obtaining a list of services and a list of dependencies of the services necessary to service the application programming interface request;
obtaining first load information for the services and second load information for the dependencies of the services;
performing an analysis using the first load information and the second load information to identify at least one of the services and/or the dependencies of the services that is likely to prevent the application programming interface request from being serviced in accordance with a service level agreement;
scaling the at least one of the services and the dependencies of the services to improve the likelihood of the application programming interface request being serviced in accordance with the service level agreement; and
servicing the application programming interface request using the scaled at least one of the services and the dependencies of the services.

12. The non-transitory machine-readable medium of claim 11, wherein the list of services comprises identifiers of executing services that will be used to complete first tasks to be performed by the application programming interface to service the application programming interface request.

13. The non-transitory machine-readable medium of claim 11, wherein the list of the dependencies comprises second identifier of other executing services that will be used to complete second tasks to be performed by the executing services identified by the list of services to service the application programming interface request.

14. The non-transitory machine-readable medium of claim 11, wherein the first load information for a first service of the services quantifies how close to a limit on a rate at which the first service is able to process requests that the first service is currently being asked to process.

15. The non-transitory machine-readable medium of claim 14, wherein the second load information for a first dependency of the dependencies quantifies how close to a second limit on a second rate at which the first dependency is able to process requests from at least the first service that the first dependency is currently being asked to process.

16. A data processing system, comprising:
a processor; and
a memory coupled to the processor to store instructions, which when executed by the processor, cause the processor to perform operations for managing services, the operations comprising:
obtaining an application programming interface request;
obtaining a list of services and a list of dependencies of the services necessary to service the application programming interface request;
obtaining first load information for the services and second load information for the dependencies of the services;
performing an analysis using the first load information and the second load information to identify at least one of the services and/or the dependencies of the services that is likely to prevent the application programming interface request from being serviced in accordance with a service level agreement;
scaling the at least one of the services and the dependencies of the services to improve the likelihood of the application programming interface request being serviced in accordance with the service level agreement; and
servicing the application programming interface request using the scaled at least one of the services and the dependencies of the services.

17. The data processing system of claim 16, wherein the list of services comprises identifiers of executing services that will be used to complete first tasks to be performed by the application programming interface to service the application programming interface request.

18. The data processing system of claim 16, wherein the list of the dependencies comprises second identifier of other executing services that will be used to complete second tasks to be performed by the executing services identified by the list of services to service the application programming interface request.

19. The data processing system of claim 16, wherein the first load information for a first service of the services quantifies how close to a limit on a rate at which the first service is able to process requests that the first service is currently being asked to process.

20. The data processing system of claim 19, wherein the second load information for a first dependency of the dependencies quantifies how close to a second limit on a second rate at which the first dependency is able to process requests from at least the first service that the first dependency is currently being asked to process.
